(19) United States
(12) Patent Application Publication
(10) Pub. No.: US 2025/0130699 A1
(43) Pub. Date: Apr. 24, 2025

(54) METHOD, APPARATUS, ELECTRONIC DEVICE, AND STORAGE MEDIUM FOR TASK PROCESSING

(71) Applicant: Beijing Zitiao Network Technology Co., Ltd., Beijing (CN)

(72) Inventor: Wenzong Ma, Beijing (CN)

(21) Appl. No.: 18/694,382

(22) PCT Filed: Sep. 20, 2022
(86) PCT No.: PCT/CN2022/119762

§ 371 Date: Mar. 21, 2024

(30) Foreign Application Priority Data
Sep. 22, 2021 (CN) 202111109220.4

(51) Int. Cl. G06F 3/04842; G06F 3/0481

(52) U.S. Cl. CPC G06F 3/04842; G06F 3/0481

(57) ABSTRACT

The present disclosure relates to a method, apparatus, electronic device, and storage medium for task processing. The method includes: in response to receiving an input request for task information in a document page, displaying a task panel in the document page, the task panel comprising at least one piece of first task information, the task information comprising the first task information; and in response to a triggering operation on the at least one piece of first task information, displaying a task area in the document page and displaying the first task information in the task area. The method can migrate the task information to different carriers, which is convenient for a user to view.

### CROSS REFERENCE TO RELATED APPLICATION(S)

This application claims priority to Chinese Patent Application No. 202111109220.4, filed on Sep. 22, 2021, and entitled “METHOD, APPARATUS, ELECTRONIC DEVICE, AND STORAGE MEDIUM FOR TASK PROCESSING”, which is hereby incorporated by reference in its entirely.

### FIELD

The present disclosure relates to the field of computer technology, and more particularly to a method, apparatus, electronic device, and storage medium for task processing.

### BACKGROUND

Objectives and Key Results (OKR) is a system and method for determining management objectives, a main object of which is to clarify the “objectives” of a company and team and measurable “key results” achieved by each objective. Each objective requires a plurality of key results. OKR can cultivate discipline of long-term thinking and planning before taking actions, which facilitates to focus everyone's work on the most important priorities, and link employees' work with truly important things in an organization.

However, using the OKR technologies in prior art, it is impossible to migrate OKR data to other carriers, which is not convenient for users to view.

### SUMMARY

In order to solve the above technical problems, the present disclosure provides a method, apparatus, electronic device, and storage medium for task processing, which can migrate OKR data to other carriers for easy viewing by users.

In a first aspect, the present disclosure provides a method for task processing comprising:
in response to receiving an input request for task information in a document page, displaying a task panel in the document page, the task panel comprising at least one piece of first task information, the task information comprising the first task information; and
in response to a triggering operation on the at least one piece of first task information, displaying a task area in the document page and displaying the first task information in the task area.

Optionally, the task information also includes second task information, and the second task information is associated with the first task information.

Optionally, the task panel further comprises a first control for choosing the first task information, the first control being located in an associated area of the first task information.

Optionally, the task panel further comprises a second control, the second control being located in an associated area of the first task information; and
the method further comprises:
in response to a triggering operation on the second control, displaying, in the task panel, at least one piece of second task information associated with the first task information.

Optionally, before the response to the triggering operation on the at least one piece of first task information, further comprising:
selecting the first task information.

Optionally, the selecting the first task information comprises:
in response to a selection operation on the first task information belonging to a first user, setting the first task information belonging to a second user into a non-selectable state; and/or
in response to the selection operation on the first task information belonging to the first user, setting second task information belonging into the second user into the non-selectable state.

Optionally, the selecting the first task information comprises:
in response to a selection operation on the first task information, setting second task information associated with the first task information into a selected state; or
in response to a selection operation on any of the second task information, setting the first task information associated with the second task information into the selected state.

Optionally, the selecting the first task information comprises:
in response to a selection operation on an identification of a first user in the task panel, setting the first task information and/or second task information belonging to the first user into a selected state.

Optionally, in response to a triggering operation on the at least one piece of first task information, the displaying a task area in the document page and the displaying the first task information in the task area comprises:
in response to there being no second task information associated with selected first task information and after the triggering operation on the at least one piece of first task information, displaying the first task information in the task area; or
in response to there being second task information associated with the selected first task information and in accordance with a determination that the second task information is not selected, preventing the triggering operation from being performed on the at least one piece of first task information; or
in response to none of the first task information being selected, preventing the triggering operation from being performed on the at least one piece of first task information.

Optionally, the selecting the first task information comprises:
in response to the first task information being set with a permission, displaying prompt information in an area associated with the first task information of the task panel.

Optionally, in response to the type of the document being a first type, the displaying the first task information in the task area comprises:
merging task areas of respective pieces of the first task information into a content block, and displaying the first task information in the merged task area.

Optionally, in response to the type of the document being a second type, the displaying the first task information in the task area comprises:
corresponding a task area of each piece of the first task information to a content block, and displaying the first task information in the task area.

In a second aspect, the present disclosure provides an apparatus for task processing comprising:
a first displaying module configured to, in response to receiving an input request for task information in the document page, display a task panel in a document page, the task panel comprising at least one piece of first task information, the task information comprising the first task information; and
a second displaying module configured to, in response to a triggering operation on the at least one piece of first task information, display a task area in the document page and displaying the first task information in the task area.

In a third aspect, the present disclosure also provides an electronic device, comprising: a processor for executing a computer program stored in a memory, the computer program, when executed by the processor, implementing the steps of the method according to the first aspect.

In a fourth aspect, the present disclosure also provides a computer-readable storage medium having a computer program stored thereon, characterized in that the computer program, when executed by a processor, implements the steps of the method according to any of the first aspect.

In a fifth aspect, the present disclosure also provides a computer program product that, when executed on a computer, causes the computer to perform the steps of the method according to any of the first aspect.

In the technical solutions provided by embodiments of the present disclosure, a task panel is displayed in a document page in response to receiving an input request for task information in the document page, the task panel comprising at least one piece of first task information, the task information comprising the first task information; and a task area is displayed in the document page and the first task information is displayed in the task area in response to a triggering operation on the at least one piece of first task information. Therefore, at least one piece of task information can be input and displayed in the document page to achieve the migration of the task information, so that the task information can be migrated to different carriers, which is convenient for users to view.

### BRIEF DESCRIPTION OF DRAWINGS

The drawings herein, which are incorporated in and constitute a part of this specification, illustrate embodiments of the present disclosure, and together with the description serve to explain the principles of the present disclosure.

For clearer description of the technical solutions in the embodiments of the present disclosure or in the prior art, the accompanying drawings needed to be used in the description of the embodiments or the prior art will be briefly introduced below. Apparently, for those of ordinary skill in the art, it is said that other drawings can be obtained from these accompanying drawings without exerting creative labor.

FIG. 1 is a schematic flowchart of a method for task processing provided by the present disclosure;

FIG. 2 is a schematic diagram of a document page provided by the present disclosure;

FIG. 3 is a schematic diagram of another document page provided by the present disclosure;

FIG. 4 is a schematic diagram of a further document page provided by the present disclosure;

FIG. 5 is a schematic diagram of a further document page provided by the present disclosure;

FIG. 6 is a schematic flowchart of another method for task processing provided by the present disclosure;

FIG. 7 is a schematic diagram of a further document page provided by the present disclosure;

FIG. 8 is a schematic flowchart of a further method for task processing provided by the present disclosure;

FIG. 9 a schematic flowchart of a further method for task processing provided by the present disclosure;

FIG. 10 is a schematic diagram of a further document page provided by the present disclosure;

FIG. 11 a schematic flowchart of a further method for task processing provided by the present disclosure;

FIG. 12 is a schematic diagram of a further document page provided by the present disclosure;

FIG. 13 a schematic flowchart of a further method for task processing provided by the present disclosure;

FIG. 14 is a schematic diagram of a further document page provided by the present disclosure;

FIG. 15 a schematic flowchart of a further method for task processing provided by the present disclosure;

FIG. 16 is a schematic diagram of a further document page provided by the present disclosure;

FIG. 17 a schematic flowchart of a further method for task processing provided by the present disclosure;

FIG. 18 is a schematic diagram of a further document page provided by the present disclosure;

FIG. 19 a schematic flowchart of a further method for task processing provided by the present disclosure;

FIG. 20 is a schematic diagram of a further document page provided by the present disclosure;

FIG. 21 a schematic flowchart of a further method for task processing provided by the present disclosure;

FIG. 22 a schematic flowchart of a further method for task processing provided by the present disclosure;

FIG. 23 is a schematic diagram of a further document page provided by the present disclosure;

FIG. 24 is a schematic diagram of a further document page provided by the present disclosure;

FIG. 25 is a schematic diagram of a further document page provided by the present disclosure;

FIG. 26 is a schematic structural diagram of an apparatus for task processing provided by the present disclosure.

### DETAILED DESCRIPTION

To understand the above objects, features and advantages of the present disclosure more clearly, the following solutions of the present disclosure will be further described. It should be noted that, without conflict, the embodiments of the present disclosure and features in the embodiments may be combined with each other.

Many specific details are set forth in the following description in order to fully understand the present disclosure, but the present disclosure may also be implemented in other ways different from that described herein. Apparently, the embodiments in the specification are only part of the embodiments of the present disclosure, not all embodiments.

The present disclosure can be applied to an electronic device, wherein the electronic device may be a computer, tablet, mobile phone or other intelligent terminal device. The electronic device has a display screen, wherein the display screen may be a touch screen or a non-touch screen. For an electronic device with a touch screen, a user can interact with the electronic device through a gesture, a finger or a touch tool (such as a stylus). For a non-touch screen electronic device, interaction with the electronic device can be achieved through an external device (such as a mouse, keyboard or camera, etc.) or speech recognition or expression recognition, etc.

The technical solutions of the present disclosure can be applied to a multimedia application, which can create different types of documents, for example, an online document, a progress report document, or a periodic replay document and the like. Accordingly, the document page of the present disclosure may be an online document page, or a progress report document page, or may be a periodic replay document page and the like.

The task information of the present disclosure may be an OKR task, audio task, video task, table task and the like. The corresponding task panel of the present disclosure may be an OKR panel, audio panel, video panel, table panel and the like.

The task information herein is described using the OKR task as an example.

An input request for the OKR task is received in a document page, and an OKR panel is displayed in the document page, the OKR panel containing at least one object (Object, O) option, the OKR task including at least one O option. In response to a triggering operation on at least one O option, a task area is displayed in the document page and the at least one O option is displayed in the task area. Therefore, at least one OKR task can be input and displayed in the document page, so that the migration of task information can be realized, and the task information can be migrated to different carriers, which is convenient for users to view.

Several specific embodiments below are described using OKR tasks as task information as an example, to describe the technical solutions of the present disclosure in detail. The implementations of other types of task information are similar to that of the present disclosure.

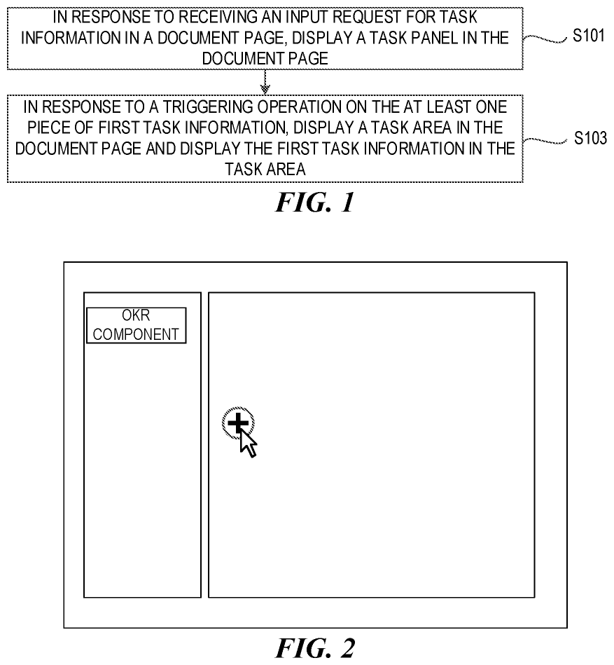

FIG. 1 is a schematic flowchart of a method for task processing provided by the present disclosure. As shown in FIG. 1, the method of the present embodiment is as follows:

S101, in response to receiving an input request for task information in a document page, displaying a task panel in the document page.

The task panel comprises at least one piece of first task information, and the task information comprises the first task information.

For example, FIG. 2 is a schematic diagram of a document page provided by the present disclosure. When a user needs to insert OKR data into a document, an operation option list can be displayed based on a triggering operation on the operation option list in an object area of the document page. The operation option list can be displayed based on the triggering operation on the operation option list in any area of the document page. The operation option list can be displayed based on the triggering operation on an operation option list anchor point in the document page, as shown in FIG. 2. The triggering operation on the operation option list can be at least one of a click operation, a double-click operation, a long press operation, and a predetermined gesture operation among others. The present embodiment does not specifically limit the triggering operation on the operation option list.

As shown in FIG. 2, the operation option list includes an OKR component button, which is used to request to input an OKR task in the document page. The OKR component button is triggered by clicking, double-clicking, long pressing, etc. to request input the OKR task in the document page. An OKR panel is displayed in the document page in response to receiving the triggering operation on the OKR component button.

It should be noted that the operation option list may also include other component buttons for requesting to input other task information in the document page. For example, the other component buttons can be a video component button, through which a video can be input in the document page by triggering the video component button, or an image component button, through which an image can be input in the document page by triggering the image component button.

When users need to insert OKR data in the document, the OKR component button can also be directly displayed in the document page, and the OKR panel can be displayed by triggering the OKR component button displayed in the document page.

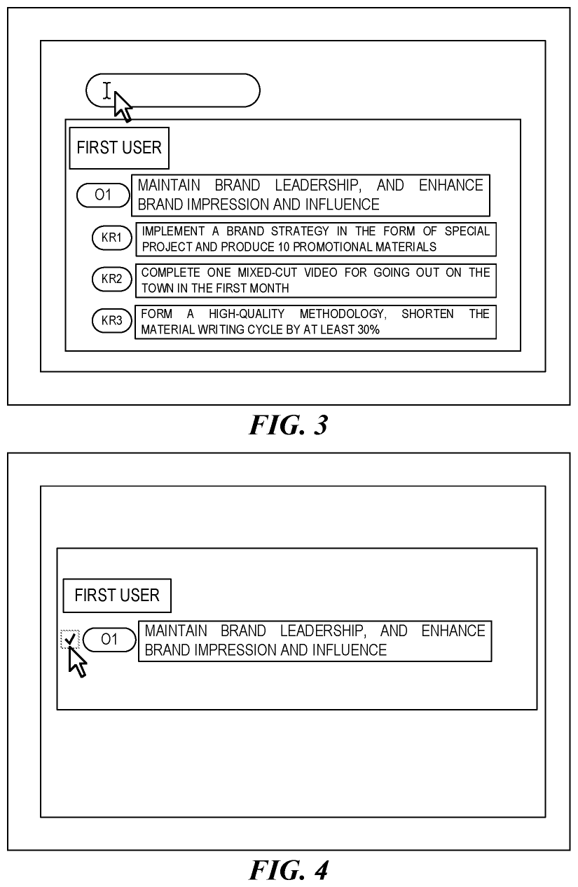

Optionally, FIG. 3 is a schematic diagram of another document page provided by the present disclosure. As shown in FIG. 3, the task panel is displayed with a search box. By entering a keyword in the search box, a user associated with the keyword can be found to obtain all O options corresponding to the user quickly.

For example, a first user corresponds to an O option, i.e., an O1 option in an OKR task panel, as shown in FIG. 3. In other embodiments, the first user may correspond to a plurality of O options. The number of messages with the first task is not specifically limited in the present embodiment.

Optionally, as shown in FIG. 3, the task information further comprises second task information, the second task information being associated with the first task information.

For example, as shown in FIG. 3, in the OKR panel, the second task information associated with the O1 option is three key result (KR) options, namely KR1 option, KR2 option, and KR3 option. For example, as shown in FIG. 3, an object information included in the O1 option is “Maintain brand leadership, and enhance brand impression and influence”, that is, the final object that needs to be achieved. Three phased objects, that is, three key results, are determined for the final object to promote the smooth completion of the final object. A key result information included in the KR1 option herein is “Implement a brand strategy in the form of special project and produce 10 promotional materials”, a key result information included in the KR2 option is “Complete one mixed-cut video for going out on the town in the first month”, and a key result information included in the KR3 option is “Form a high-quality methodology, shorten the material writing cycle by at least 30%”.

Optionally, FIG. 4 is a schematic diagram of a further document page provided by the present disclosure. As shown in FIG. 4, the task panel further comprises a first control for choosing the first task information, the first control being located in an associated area of the first task information.

For example, the first control can be a checkbox, as shown in FIG. 4. The first user corresponds to the O1 option, and there is a checkbox corresponding to the starting position of the O1 option. By selecting the checkbox corresponding to the O1 option, the O1 option can be chosen. When selecting the checkbox, an identification as shown in FIG. 4 can be displayed, which can prompt the user that the checkbox has been selected, making it easy for the user to operate. After selecting the checkbox, a check mark as shown in FIG. 4 can be displayed in the checkbox, or the checkbox can be filled in black, or other identifications can be displayed in the checkbox. The checkbox can be a square as shown in FIG. 4, or other shapes such as a circle or a triangle.

In other embodiments, the first control may also be a button, a touch identification, etc. The specific implementation of the first control is not limited in the present embodiment.

It should be noted that FIG. 4 only shows that the first control is located at the starting position of the O option for example. In other embodiments, the first control may be located at the end position of the O option or may be located at other associated areas of the O option optionally. The position of the first control is not particularly limited in the present embodiment.

S103, in response to a triggering operation on the at least one piece of first task information, displaying a task area in the document page and displaying the first task information in the task area.

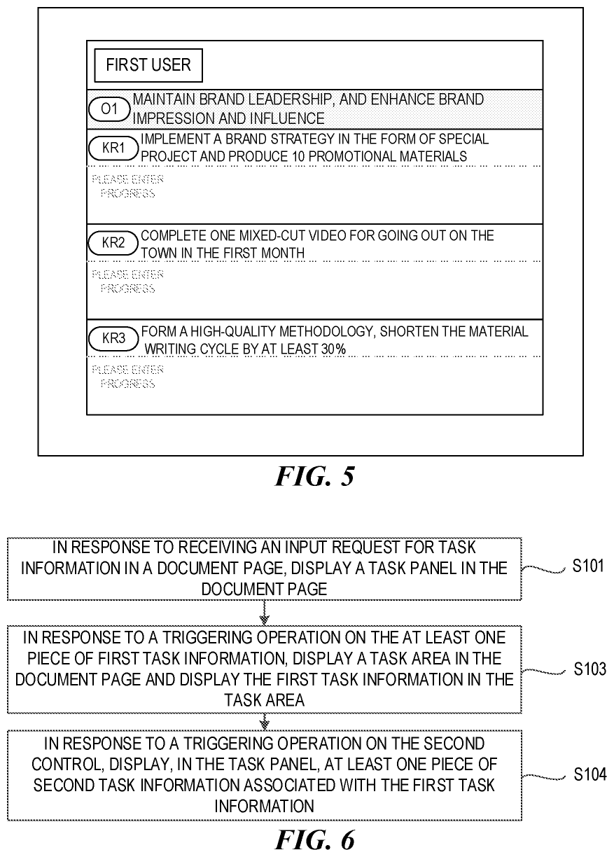

The user triggers the O1 option, as shown in FIG. 3. In response to the triggering operation on the O1 option, a task area is inserted in the document page, and object information included in the O1 option is displayed in the task area, as shown in FIG. 5. In other embodiments, a plurality of O options corresponding to the first user may be triggered, and in response to the triggering operation on the plurality of O options, the object information included in the plurality of O options may be displayed in the task area.

In the present embodiment, the task panel is displayed in the document page in response to receiving the input request for task information in the document page, the task panel comprising the at least one piece of first task information, the task information comprising the first task information; and the task area is displayed in the document page and the first task information is displayed in the task area in response to the triggering operation on the at least one piece of first task information. Therefore, at least one piece of task information can be input and displayed in the document page to achieve the migration of the task information, so that the task information can be migrated to different carriers, which is convenient for users to view.

FIG. 6 is a schematic flowchart of another method for task processing provided by the present disclosure. FIG. 6 is based on the embodiment shown in FIG. 1, further comprising:

S104, in response to a triggering operation on the second control, displaying, in the task panel, at least one piece of second task information associated with the first task information.

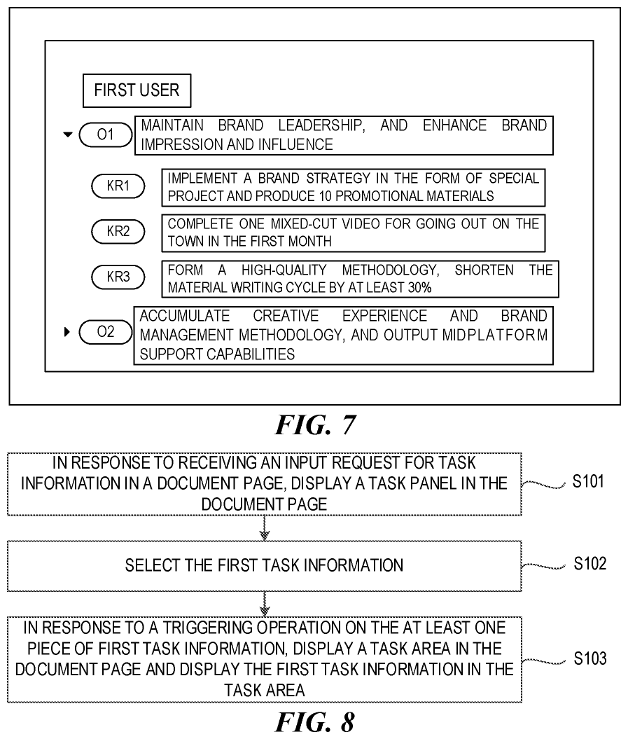

The task panel further comprises a second control, the second control being located in an associated area of the first task information. For example, the second control can be a collapse button. For example, FIG. 7 is a schematic diagram of a further document page provided by the present disclosure. As shown in FIG. 7, the OKR panel includes two collapse buttons, wherein one collapse button is located in an association area near the O1 option, and the other collapse button is located in an association area near the O2 option.

With the collapse button corresponding to the O2 option not triggered, as shown in FIG. 7, the collapse button corresponding to the O2 option may be a triangular button, the top of which points to the O2 option. After triggering the collapse button corresponding to the O1 option, the collapse button corresponding to the O1 option is a version of the collapse button corresponding to the O2 option that has been rotated 90 degrees clockwise, and displays the KR1 option, the KR2 option and the KR3 option associated with the O1 option. The different forms of the collapse button can indicate whether the collapse button is in a triggered state, which is convenient for the user to operate. In other embodiments, a untriggered collapse button may also be a plus button, and a triggered collapse button may be a minus button. The present embodiment does not specifically limit the specific form of the collapse button, but only limits that the forms of the triggered collapse button and the untriggered collapse button are different.

It should be noted that FIG. 7 only illustrates the second control as a collapse button for example, and in practical applications, the implementation of the second control is not limited.

In the present embodiment, in response to the triggering operation on the second control, at least one piece of second task information associated with the first task information is displayed in the task panel. The second task information can be hidden by the second control, so that a display interface of the task panel is relatively simple, enhancing user experience.

FIG. 8 is a schematic flowchart of a further method for task processing provided by the present disclosure. FIG. 8 is based on the embodiment shown in FIG. 1, before performing S103, further comprising:

S102, selecting the first task information.

Before triggering the first task information, the first task information to be input into the document page is selected. A plurality of task information can be selected, and triggering operations can be performed on the selected plurality of task information. Therefore, the plurality of task information can be input into the document page at one time, which can realize batch input of a plurality of task information at one time, reduce the number of operations, and facilitate user operation.

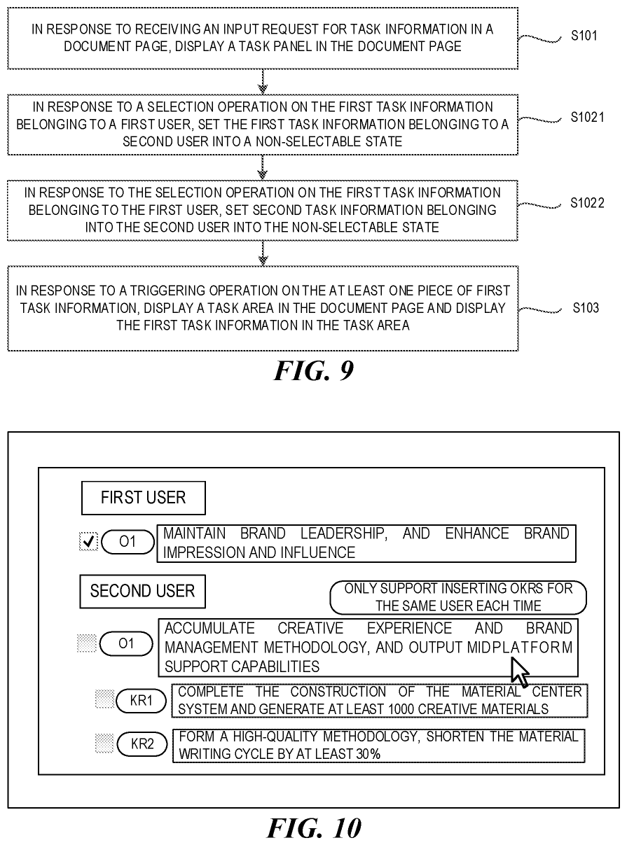

As a specific description of a possible implementation of S102, as shown in FIG. 9:

S1021, in response to a selection operation on the first task information belonging to a first user, setting the first task information belonging to a second user into a non-selectable state.

For example, FIG. 10 is a schematic diagram of a further document page provided by the present disclosure. As shown in FIG. 10, the OKR panel includes a first user and a second user. The first user corresponds to the O1 option, and the second user corresponds to the O1 option. In the case that the O1 option corresponding to the first user is triggered and selected, a prompt message is displayed when a cursor is moved to the O1 option corresponding to the second user, wherein the prompt message can be “Only support inserting the OKR of a same user each time” for example, as shown in FIG. 10. The prompt message is used to indicate that the first task information of the second user is in a non-selectable state. At this time, the user cannot select the O1 option for the second user.

S1022, in response to the selection operation on the first task information belonging to the first user, setting second task information belonging into the second user into the non-selectable state.

By way of example, continuing to refer to FIG. 10, the OKR panel also includes the KR1 option and KR2 option associated with the O1 option corresponding to the second user. In the case that the O1 option corresponding to the first user is triggered and selected, the prompt message is displayed when a cursor is moved to the KR1 option and KR2 option corresponding to the second user. The prompt message is used to indicate that the second task information of the second user is in a non-selectable state currently. At this time, the user cannot select the KR1 option and KR2 option for the second user.

In should be noted that FIG. 9 illustrates only the performance of S1021-S1022 as an example, and in practical applications, S1021 or S1022 may be performed additionally. The present disclosure is not particularly limited thereto.

In the present embodiment, the first task information belonging to a second user is set into the non-selectable state in response to a selection operation on the first task information belonging to the first user; and/or the second task information belonging into the second user is set into the non-selectable state in response to the selection operation on the first task information belonging to the first user. Therefore, the first task information input into the document page at a single time corresponds to the same user.

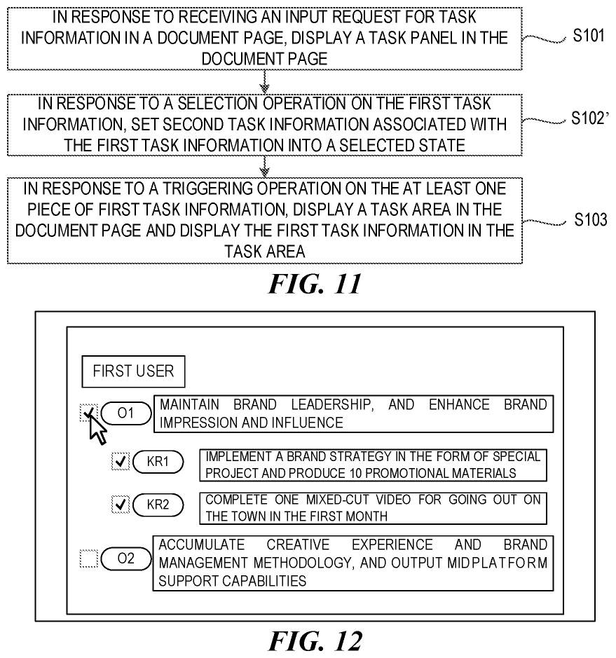

As a specific description of another possible implementation of S102, as shown in FIG. 11:

S102′, in response to a selection operation on the first task information, setting second task information associated with the first task information into a selected state.

By way of example, FIG. 12 is a schematic diagram of a further document page provided by the present disclosure. As shown in FIG. 12, the OKR panel includes a first user, and the first user corresponds to an O1 option and an O2 option. The O1 option is associated with a KR1 option and a KR2 option. After selecting the O1 option, as shown in FIG. 12, the KR1 option and KR2 option associated with the O1 option are set into a selected state by default, and there is no need to perform a plurality of operations on the plurality of KR options corresponding to the first user.

In the present embodiment, second task information associated with the first task information is set into a selected state in response to a selection operation on the first task information, to achieve the association of the first task information and the second task information, avoiding performing a plurality of selection operations on the plurality of second task information associated with the first task information, improving the efficiency and convenience of the operation.

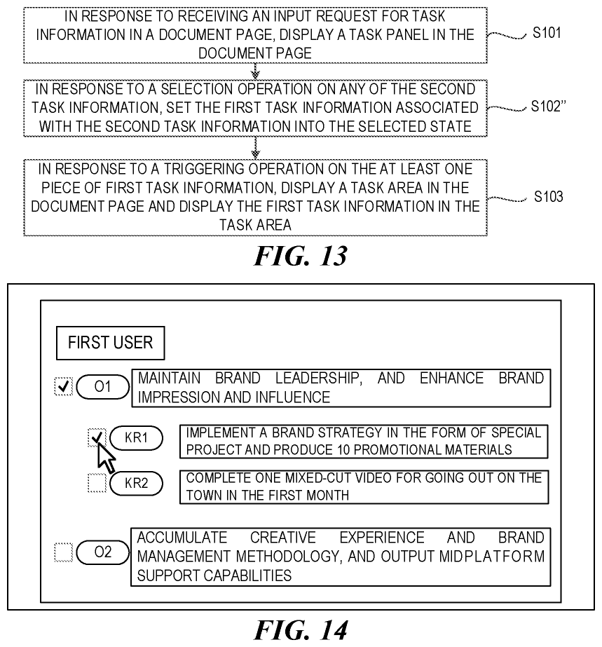

As a specific description of another possible implementation of S102, as shown in FIG. 13:

S102″, in response to a selection operation on any of the second task information, setting the first task information associated with the second task information into the selected state.

By way of example, FIG. 14 is a schematic diagram of a further document page provided by the present disclosure. As shown in FIG. 14, the OKR panel includes a first user, and the first user corresponds to the O1 option and the O2 option. The O1 option is associated with the KR1 option and the KR2 option. After selecting the KR1 option associated with the O1 option, as shown in FIG. 14, the O1 option is displayed in the selected state, without the user selecting the O1 option again. In other implementations, it is possible that the O1 option is displayed in the selected state after selecting the KR2 option associated with the O1 option.

In the present embodiment, the first task information associated with the second task information is set into the selected state in response to a selection operation on any of the second task information, to achieve the association between the first task information and the second task information, avoiding performing selection operation on the first task information associated with the second task information, improving the efficiency and convenience of the operation.

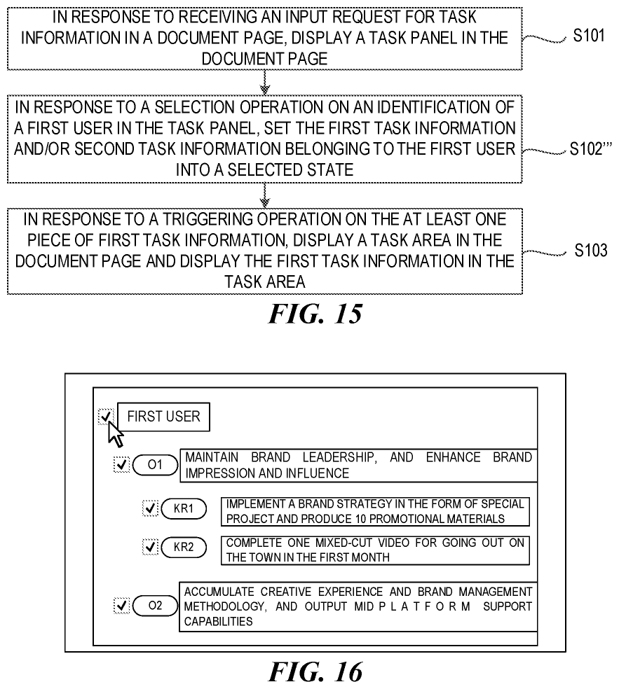

As a specific description of a further possible implementation of S102, as shown in FIG. 15:

S102′″, in response to a selection operation on an identification of a first user in the task panel, setting the first task information and/or second task information belonging to the first user into a selected state.

By way of example, FIG. 16 is a schematic diagram of a further document page provided by the present disclosure. As shown in FIG. 16, the OKR panel includes a first user. The first user corresponds to O1 option and O2 option, and O1 option are associated with KR1 option and KR2 option are displayed in the selected state by default. The checkbox for the first user is select in the OKR panel, as shown in FIG. 16. The O1 option and O2 option corresponding to the first user, and the KR1 option and KR2 option associated with the O1 option are selected, which can reduce the number of operations for the same user.

In other implementation methods, it is also possible that after selecting the checkbox for the first user in the OKR panel, the KR1 option and KR2 option associated with the O1 option corresponding to the first user are displayed in the selected state by default. Alternatively, it is also possible that after selecting the checkbox for the first user in the OKR panel, the O1 option and O2 option corresponding to the first user are displayed in the selected state by default.

It should be noted that FIG. 16 only shows the identification of the first user as a checkbox by way of example. In other implementations, the identification of the first user may also be a button, a touch identification, etc. The specific implementation of the identification of the first user is not limited in the present embodiment.

In the present embodiment, the first task information and/or second task information belonging to the first user are set into a selected state in response to a selection operation on an identification of a first user in the task panel. For the same user, the number of operations for the task information can be reduced, which is convenient for the user to operate and improves the efficiency of user operation.

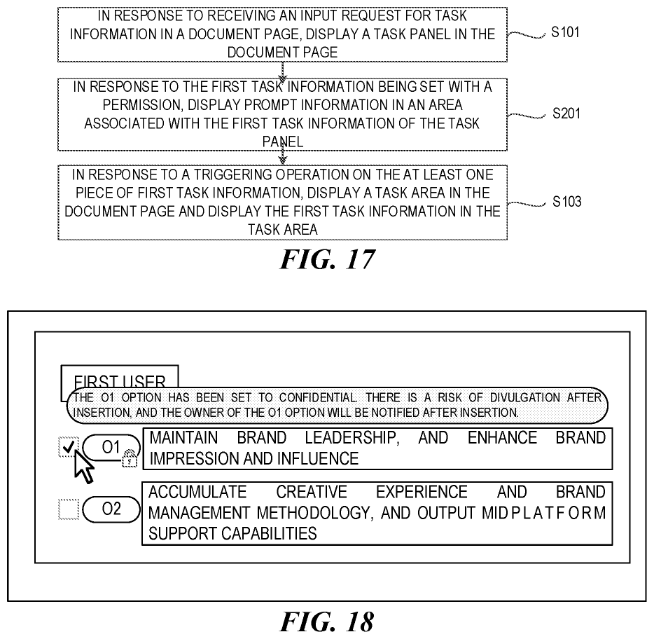

As a specific description of a further possible implementation of S102, as shown in FIG. 17:

S201, in response to the first task information being set with a permission, displaying prompt information in an area associated with the first task information of the task panel.

By way of example, FIG. 18 is a schematic diagram of a further document page provided by the present disclosure. As shown in FIG. 18, the OKR panel includes a first user, and the first user corresponds to the O1 option and the O2 option, wherein the O1 option has been set with a permission. For example, a permission identification can be displayed as shown in FIG. 18. The associated area near the O1 option displays prompt information, such as “The O1 option has been set to confidential. There is a risk of divulgation after insertion, and the owner of the O1 option will be notified after insertion.”

A notification to the owner of the O1 option can be triggered and authorization from the owner of the O1 option is required to insert the O1 option into the document page, ensuring the privacy of the O1 option. Alternatively, a notification to the owner of the O1 option can be triggered, and not all contents of the O1 option will be expanded and displayed in the document page since the O1 option has been set with a permission, ensuring the privacy of the O1 option.

In the present embodiment, the prompt information is displayed in an area associated with the first task information of the task panel in response to the first task information being set with a permission, ensuring the privacy of the first task information.

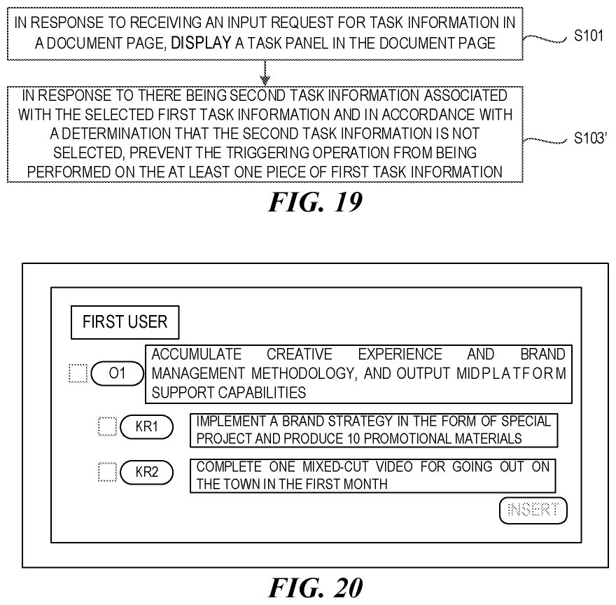

FIG. 19 a schematic flowchart of a further method for task processing provided by the present disclosure. FIG. 19 is based on the embodiment shown in FIG. 1, a specific description of a possible implementation when performing S103 being as follows:

S103′, in response to there being second task information associated with the selected first task information and in accordance with a determination that the second task information is not selected, preventing the triggering operation from being performed on the at least one piece of first task information.

By way of example, FIG. 20 is a schematic diagram of a further document page provided by the present disclosure. As shown in FIG. 20, the OKR panel includes the O1 option corresponding to the first user, the KR1 option and KR2 option associated with the O1 option, and an insert button. If the KR1 and KR2 options are not selected, it is equivalent to the O2 option corresponding to the first user having not been selected. At this point, no task information has been selected to input into the document page, that is there is no content input into the document page. At this time, the insert button is in a state that is prevented from being triggered. For example, the insert button can be displayed in gray, as shown in FIG. 20, or the insert button can be hidden to indicate to the user that the insert button is currently in a non-triggerable state. That is to say, when the second task information is not selected, the operation to input the first task information into the document page cannot be performed, which can avoid an invalid operation.

It should be noted that FIG. 20 only indicates whether the triggering operation on the first task information can be triggered by the states of the insert button. In practical applications, there are no specific restrictions on the specific implementation of displaying whether the current first task information can be triggered.

In the present embodiment, in response to there being second task information associated with the selected first task information and in accordance with a determination that the second task information is not selected, the triggering operation is prevented from being performed on the at least one piece of first task information, so that the operation on the first task information associated with the second task information cannot be entered into the document page, which can avoid an invalid operation and is conducive to improving the efficiency of user operations. It is also possible to avoid a mis-operation on the task information, and in turn avoid a mis-operation on the document page, which is conducive to improving the efficiency of user operations.

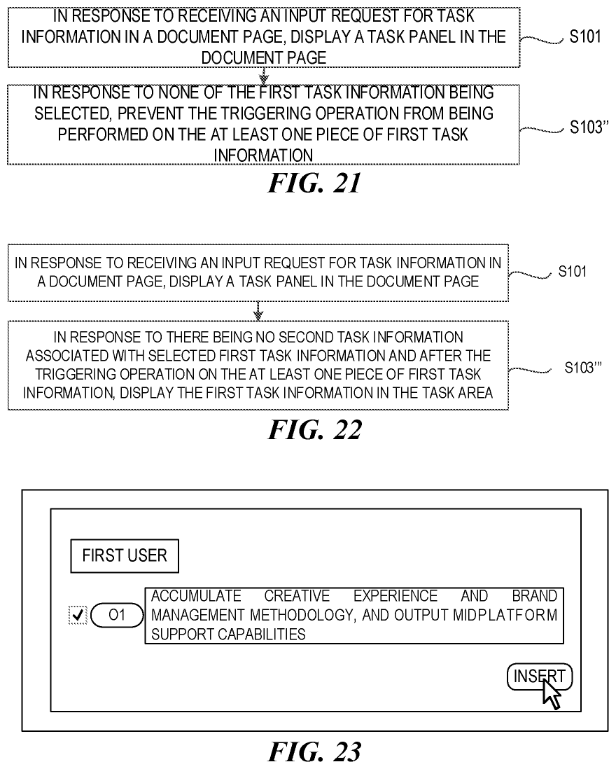

FIG. 21 is a further method for task processing provided by the present disclosure. FIG. 21 is based on the embodiment shown in FIG. 1, a specific description of another possible implementation when performing S103 being as follows:

S103″, in response to none of the first task information being selected, preventing the triggering operation from being performed on the at least one piece of first task information.

For example, as shown in FIG. 20, when the O1 option is not selected-when none of the task information is selected to input into the document page—that is, when there is no input content in the document page, the insert button is in the state that is prevented from being triggered at this time. That is to say, when the first task information is not selected, the operation to input the first task information into the document page cannot be performed, which can avoid an invalid operation.

In the present embodiment, in response to none of the first task information being selected, the triggering operation is prevented from being performed on the at least one piece of first task information, so that when the first task information is not selected, the operation to input the first task information into the document page cannot be performed, which can avoid an invalid operation and is conducive to improving the efficiency of user operations. It is also possible to avoid a mis-operation on the task information, and in turn avoid a mis-operation on the document page, which is conducive to improving the efficiency of user operations.

FIG. 22 is a further method for task processing provided by the present disclosure. FIG. 22 is based on the embodiment shown in FIG. 1, a specific description of another possible implementation when performing S103 being as follows:

S103′″, in response to there being no second task information associated with selected first task information and after the triggering operation on the at least one piece of first task information, displaying the first task information in the task area.

For example, as shown in FIG. 23, the OKR panel includes an O1 option corresponding to the first user, as well as an insert button. There is no KR option associated with the O1 option. After selecting the O1 option, the insert button transitions from a non-triggerable state to a triggerable state. For example, the insert button in the OKR panel displays in a normal color, as shown in FIG. 23, or the insert button is displayed.

After selecting the O1 option, the insert button is triggered. In response to the triggering for the insert button, the selected O1 option is input into the document page to form the document page as shown in FIG. 5. The document page includes the task area, and the O1 option is displayed in the task area. The O1 option is input into the document page by triggering the insert button, so that it is possible to avoid a mis-operation on the first task information, and in turn avoid a mis-operation on the document page, which improved the efficiency of user operations.

In the present embodiment, in response to there being no second task information associated with selected first task information and after the triggering operation on the at least one piece of first task information, the first task information is displayed in the task area, so that the input of the first task information is triggered in the document page after the selection of the first task information, which can avoid an invalid operation and is conducive to improving the efficiency of user operations. It is also possible to avoid a mis-operation on the task information, and in turn avoid a mis-operation on the document page, which is conducive to improving the efficiency of user operations.

Based on the above embodiment, a specific description of a possible implementation of the step of displaying the first task information in the task area in S103 is as follows:
merging task areas of respective pieces of the first task information into a content block and displaying the first task information in the merged task area.

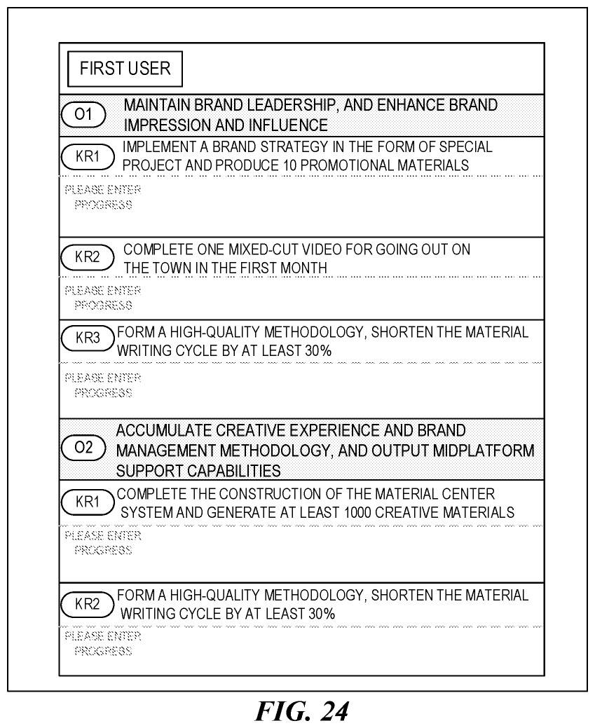

If the type of the document is a first type—for example, the first type can be an online document, one content block is displayed in the document page when a plurality of OKR tasks are input in a batch at one time in the document page, as shown in FIG. 24. The task area in the content block displays all the O options input at this time.

Optionally, all O options displayed in the task area form as a whole content block. When operating on the content block and responding to the content block, such as performing deletion operation, sharing operation, or cutting operation on the content block, all O options in the content block simultaneously respond to the deletion operation, sharing operation, and cutting operation, to reduce the number of user operations and improve the efficiency of user operations.

In the present embodiment, in response to the type of the document being the first type, task areas of respective pieces of the first task information are merged into a content block, and the first task information is displayed in the merged task area, to facilitate the overall operation on the first task information in the content block, which can improve the convenience of operations.

A specific description of another possible implementation of the step of displaying the first task information in the task area in S103 being as follows:
corresponding a task area of each piece of the first task information to a content block and displaying the first task information in the task area.

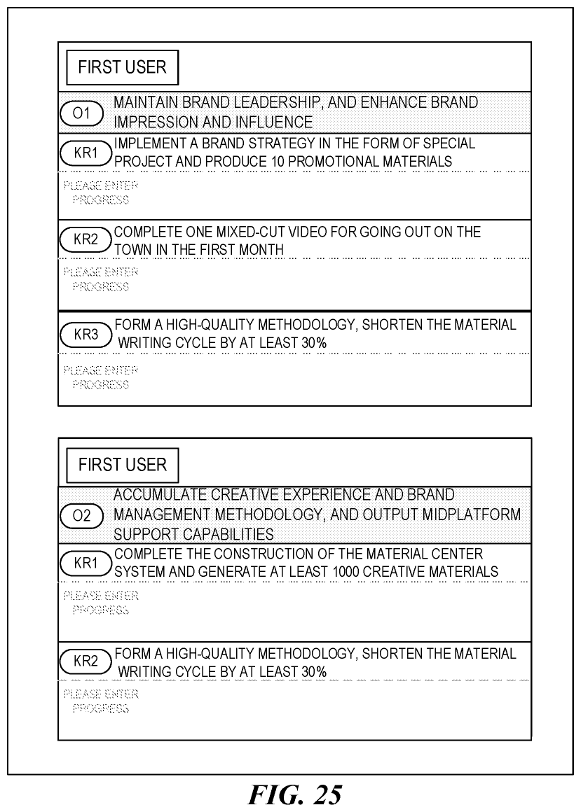

If the type of the document is a second type—for example, the second type can be a progress report document, or a periodic replay document, a plurality of content blocks is displayed in the document page when a plurality of OKR tasks is input in a batch at one time in the document page, as shown in FIG. 25. One O option is displayed in a respective content block in the task area. Each of the content blocks can be operated separately—for example, the deletion operation can be performed on O1 option, and the sharing operation can be performed on the O2 option. The O options in respective content blocks can respond to the corresponding operation separately, and different operations can be performed on different O options to improve the flexibility of the operations.

In the present embodiment, in response to the type of the document being the first type, a task area of each piece of the first task information is corresponded to a content block, and the first task information is displayed in the task area. It is possible to perform different operations on the first task information in the respective content blocks separately, to enhance the flexibility of the operations.

Alternatively, in some embodiments of the present application, the first type may be a progress report document or a periodic replay document; and the second type may be an online document. Accordingly, in response to the type of document being the first type, a task area of each piece of the first task information is corresponded to a content block, and the first task information is displayed in the task area; and in response to the type of document being the second type, task areas of respective pieces of the first task information are merged into a content block, and the first task information is displayed in the merged task area.

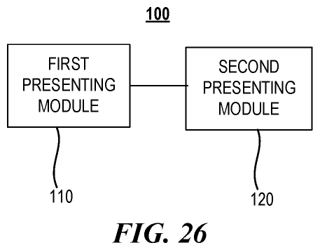

The present disclosure also provides an apparatus for task processing. FIG. 26 is a schematic structural diagram of an apparatus for task processing provided by the present disclosure. As shown in FIG. 26, the apparatus 100 for task processing comprises: a first displaying module 110 configured to, in response to receiving an input request for task information in the document page, display a task panel in a document page, the task panel comprising at least one piece of first task information, the task information comprising the first task information; and a second displaying module 120 configured to, in response to a triggering operation on the at least one piece of first task information, display a task area in the document page and displaying the first task information in the task area.

Optionally, the task information further comprises second task information, the second task information being associated with the first task information.

Optionally, the task panel further comprises a first control for choosing the first task information, the first control being located in an associated area of the first task information.

Optionally, the task panel further comprises a second control, the second control being located in an associated area of the first task information.

The first displaying module 110 is further configured to, in response to a triggering operation on the second control, displaying, in the task panel, at least one piece of second task information associated with the first task information.

Optionally, the apparatus 100 for task processing further comprises a selection module configured to select the first task information.

Optionally, the selection module is configured to, in response to a selection operation on the first task information belonging to a first user, set the first task information belonging to a second user into a non-selectable state; and/or in response to the selection operation on the first task information belonging to the first user, set second task information belonging into the second user into the non-selectable state.

Optionally, the selection module is further configured to, in response to a selection operation on the first task information, set second task information associated with the first task information into a selected state; or in response to a selection operation on any of the second task information, set the first task information associated with the second task information into the selected state.

Optionally, the selection module is further configured to, in response to a selection operation on an identification of a first user in the task panel, set the first task information and/or second task information belonging to the first user into a selected state.

Optionally, the second display module 120 is further configured to, in response to there being no second task information associated with selected first task information and after the triggering operation on the at least one piece of first task information, display the first task information in the task area; or in response to there being second task information associated with the selected first task information and in accordance with a determination that the second task information is not selected, prevent the triggering operation from being performed on the at least one piece of first task information; or in response to none of the first task information being selected, prevent the triggering operation from being performed on the at least one piece of first task information.

Optionally, the first displaying module 110 is further configured to, in response to the first task information being set with a permission, display prompt information in an area associated with the first task information of the task panel.

Optionally, the second display module 120 is further configured to, in response to the type of the document being a first type, merge task areas of respective pieces of the first task information into a content block and display the first task information in the merged task area.

Optionally, the second displaying module 120 is further configured to, in response to the type of the document being a second type, correspond a task area of each piece of the first task information to a content block and display the first task information in the task area.

The technical solutions corresponding to the apparatus of this embodiment that can be used to execute the above method embodiments will not be repeated herein, as their implementation principles and technical effects are similar.

The present disclosure also provides an electronic device, comprising: a processor for executing a computer program stored in a memory, the computer program, when executed by the processor, implementing the steps of the method of the above method embodiments.

The present disclosure also provides a computer-readable storage having a computer program stored thereon, that when executed by a processor, implements the steps of the method of the above method embodiments.

The present disclosure also provides a computer program product that when executed on a computer, causing the computer to perform the steps of the method of the above method embodiments.

Herein, it should be noted that relational terms such as “first” and “second” are only used to distinguish one entity or operation from another entity or operation, and do not necessarily require or imply any actual relationship or order between these entities or operations. Moreover, the terms “comprises”, “comprising”, or any other variant thereof are intended to cover non-exclusive inclusion, so that a process, method, article, or device that includes a series of elements not only includes those elements, but also includes other elements not explicitly listed, or includes elements inherent to such a process, method, article, or device. Without further limitation, an element defined by the phrase “comprises a . . . ” does not exclude the presence of additional identical elements in the process, method, article, or device that includes the element.

The foregoing is merely a detailed description of the present disclosure to enable those skilled in the art to understand or implement the present disclosure. Various modifications to these embodiments will be apparent to those skilled in the art, and the general principles defined herein may be implemented in other embodiments without departing from the spirit or scope of the present disclosure. Accordingly, the present disclosure will not be limited to the embodiments described herein, but will be subject to the widest scope consistent with the principles and novel features disclosed herein.

What is claimed is:

1. A method for task processing, comprising:
in response to receiving an input request for task information in a document page, displaying a task panel in the document page, the task panel displaying at least one piece of first task information, the task information comprising the first task information; and
in response to a triggering operation on the at least one piece of first task information, displaying a task area in the document page and displaying the first task information in the task area.

2. The method of claim 1, wherein the task information further comprises second task information, the second task information being associated with the first task information.

3. The method of claim 1, wherein the task panel further comprises a first control for choosing the first task information, the first control being located in an associated area of the first task information.

4. The method of claim 1, wherein the task panel further comprises a second control, the second control being located in an associated area of the first task information; and
wherein the method further comprises:
in response to a triggering operation on the second control, displaying, in the task panel, at least one piece of second task information associated with the first task information.

5. The method of claim 1, wherein before the response to the triggering operation on the at least one piece of first task information, the method further comprises:
selecting the first task information.

6. The method of claim 5, wherein the selecting the first task information comprises:
in response to a selection operation on the first task information belonging to a first user, setting the first task information belonging to a second user into a non-selectable state;
and/or in response to the selection operation on the first task information belonging to the first user, setting second task information belonging into the second user into the non-selectable state.

7. The method of claim 5, wherein the selecting the first task information comprises:
in response to a selection operation on the first task information, setting second task information associated with the first task information into a selected state; or
in response to a selection operation on any of the second task information, setting the first task information associated with the second task information into the selected state.

8. The method of claim 5, wherein the selecting the first task information comprises:
in response to a selection operation on an identification of a first user in the task panel, setting the first task information and/or second task information belonging to the first user into a selected state.

9. The method of claim 1, wherein in response to a triggering operation on the at least one piece of first task information, the displaying a task area in the document page and the displaying the first task information in the task area comprises:
in response to there being no second task information associated with selected first task information and after the triggering operation on the at least one piece of first task information, displaying the first task information in the task area; or
in response to there being second task information associated with the selected first task information and in accordance with a determination that the second task information is not selected, preventing the triggering operation from being performed on the at least one piece of first task information; or
in response to none of the first task information being selected, preventing the triggering operation from being performed on the at least one piece of first task information.

10. The method of claim 5, wherein the selecting the first task information comprises:
in response to the first task information being set with a permission, displaying prompt information in an area associated with the first task information of the task panel.

11. The method of claim 1, wherein in response to the type of the document being a first type, the displaying the first task information in the task area comprises:
merging task areas of respective pieces of the first task information into a content block, and displaying the first task information in the merged task area.

12. The method of claim 1, wherein in response to the type of the document being a second type, the displaying the first task information in the task area comprises:
corresponding a task area of each piece of the first task information to a content block, and displaying the first task information in the task area.

13. (canceled)

14. An electronic device, comprising: a processor for executing a computer program stored in a memory, the computer program, when executed by the processor, causes the processor to implement operations comprising:
in response to receiving an input request for task information in a document page, displaying a task panel in the document page, the task panel displaying at least one piece of first task information, the task information comprising the first task information; and
in response to a triggering operation on the at least one piece of first task information, displaying a task area in the document page and displaying the first task information in the task area.

15. A non-transitory computer-readable storage medium having a computer program stored thereon, wherein the computer program, when executed by a processor, causes the processor to implement operations comprising:
in response to receiving an input request for task information in a document page, displaying a task panel in the document page, the task panel displaying at least one piece of first task information, the task information comprising the first task information; and
in response to a triggering operation on the at least one piece of first task information, displaying a task area in the document page and displaying the first task information in the task area.

16. The electronic device of claim 14, wherein the task information further comprises second task information, the second task information being associated with the first task information.

17. The electronic device of claim 14, wherein the task panel further comprises a first control for choosing the first task information, the first control being located in an associated area of the first task information.

18. The electronic device of claim 14, wherein the task panel further comprises a second control, the second control being located in an associated area of the first task information; and
wherein the acts further comprise:
in response to a triggering operation on the second control, displaying, in the task panel, at least one piece of second task information associated with the first task information.

19. The electronic device of claim 14, wherein before the response to the triggering operation on the at least one piece of first task information, the acts further comprise:
selecting the first task information.

20. The electronic device of claim 19, wherein the selecting the first task information comprises:
in response to a selection operation on the first task information belonging to a first user, setting the first task information belonging to a second user into a non-selectable state; and/or
in response to the selection operation on the first task information belonging to the first user, setting second task information belonging into the second user into the non-selectable state.

21. The electronic device of claim 19, wherein the selecting the first task information comprises:
in response to a selection operation on the first task information, setting second task information associated with the first task information into a selected state; or
in response to a selection operation on any of the second task information, setting the first task information associated with the second task information into the selected state.
